(19) United States
(12) Patent Application Publication
(10) Pub. No.: US 2013/0100512 A1
(43) Pub. Date: Apr. 25, 2013

(54) ONE-DIMENSIONAL SCANNING DISPLAYER FOR PROJECTING IMAGE ONTO PUPILS

(71) Applicants: Ching-Cherng Sun, Yangmei City (TW); Tzu-Pin Kao, Tainan City (TW)

(72) Inventors: Ching-Cherng Sun, Yangmei City (TW); Tzu-Pin Kao, Tainan City (TW)

(73) Assignee: NATIONAL CENTRAL UNIVERSITY, Taoyuan County (TW)

(21) Appl. No.: 13/280,560

(22) Filed: Oct. 25, 2011

(51) Int. Cl. G02B 5/32

(52) U.S. Cl. 359/19

(57) ABSTRACT

A one-dimensional scanning displayer for projecting image onto pupils includes a one-dimensional scanning displayer, a critical optics device. The one-dimensional scanning displayer further comprises a light source, a displayer, a mechanical one-dimensional scanner, a lens set and a light splitter. The light source emits light beams through a light guide element. The light guide element unambiguously projects a receiving image onto the displayer via the light splitter. A mapping image on the displayer transmits through the lens set to reach to the mechanical one-dimensional scanner. The mechanical one-dimensional scanner reflects the mapping image to a critical optics device. The critical optics device transforms the mapping image into a hologram and projects the hologram onto user's pupils for a user to watch.

### BACKGROUND OF THE INVENTION

1. Field of the Invention

The present invention relates to an image display device, more particularly to a one-dimensional scanning displayer for projecting image onto pupils.

2.Description of Related Art

Nowadays, LED monitors are widely used to the portable devices, such as smart phones, tablet computers, handheld video game devices . . . etc. Thus, people can enjoy different kinds of entertainments from these portable devices in the leisure time. However, to watch the video or movie on these portable devices for several hours often causes people to feel uncomfortable, especially on their necks and hands.

In order to improve the shortcoming mentioned above, a manufacturer designs one image display device which is worn on a user's head. The image display device uses a mapping device to show the image in front of the user's eyes. Thus, the user can comfortably enjoy the video or movie via the image display device.

Unfortunately, the image display device still has one shortcoming. The users cannot be aware of the traffic around themselves when they wear the image display to go on the road because the image mapped from the image display device occupies the user's eyes and the view around the user cannot be transparent into the user's eyes. Although some manufacturers try to use beam splitters or light guide devices to overcome this shortcoming, the image becomes ambiguous because of the energy loss of photons.

The present invention has arisen to mitigate and/or obviate the disadvantages of the conventional.

### SUMMARY OF THE INVENTION

The main objective of the present invention is to provide an improved image display device, more particularly to a one-dimensional scanning displayer for projecting image onto pupils.

To achieve the objective, a one-dimensional scanning displayer for projecting image onto pupils comprises a light source, a displayer, a mechanical one-dimensional scanner, a lens set, a light splitter and a critical optics device, the light source emitting light beams through a light guide element, the light guide element unambiguously projecting a receiving image onto the displayer via the light splitter, a mapping image on the displayer transmitting through the lens set to reach to the mechanical one-dimensional scanner, the mechanical one-dimensional scanner reflecting the mapping image to a critical optics device, the critical optics device transforming the mapping image into a hologram and projecting the hologram onto user's pupils for a user to watch.

The light source is a plurality of LED illuminants with different colors mixing with a white-light LED. The light guide element can be replaced by a light diffuser or a combination of a light guide device and the light diffuser. The mechanical one-dimensional scanner further comprises a reflective sheet pivoted on an axis, the reflective sheet rotating or vibrating with a constant angle increment. The critical optics device is a holographic optics device.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a one-dimensional scanning displayer for projecting image onto pupils for showing the arrangement of the first embodiment;

FIG. 2 is a perspective view of the one-dimensional scanning displayer for projecting image onto pupils for showing the arrangement of the second embodiment;

FIG. 3 is a perspective view of the one-dimensional scanning displayer for projecting image onto pupils for showing the arrangement of the third embodiment;

FIG. 4 is a perspective view of the one-dimensional scanning displayer for projecting image onto pupils for showing the arrangement of the fourth embodiment;

FIG. 5 is a perspective view of the one-dimensional scanning displayer for projecting image onto pupils applied in glasses; and

FIG. 6 is a perspective view for showing a user wearing the glasses with one-dimensional scanning displayer for projecting image onto pupils.

### DETAILED DESCRIPTION OF THE INVENTION

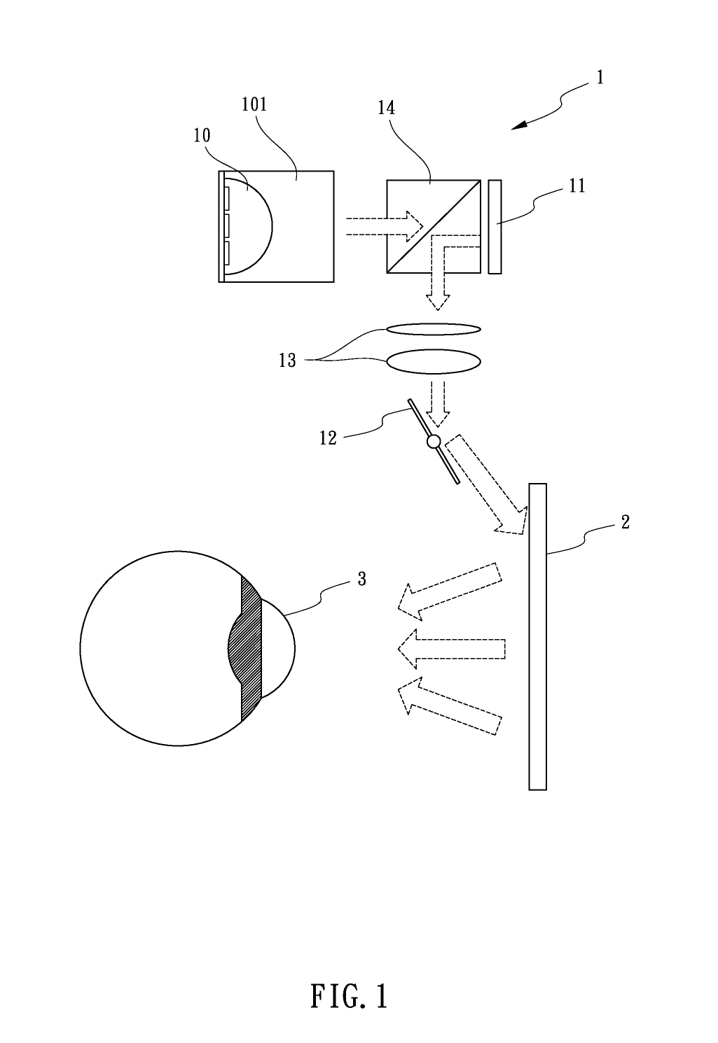

Referring to FIG. 1, a one-dimensional scanning displayer 1 for projecting image onto pupils comprises a light source 10, a displayer 11, a mechanical one-dimensional scanner 12, a lens set 13 and a light splitter 14. The light source 10 is a plurality of LED illuminants mixing with a white-light LED in the present embodiment. The light source 10 emits light beams with a constant wavelength to pass through a light guide element 101. The light guide element 101 unambiguously projects a receiving image onto the displayer 11 via the light splitter 14. The displayer 11 is a reflective panel in the present embodiment. A mapping image on the displayer 11 is transmitting to the light splitter 14 and is further deflected by the light splitter 14 to pass through the lens set 13 to reach to the mechanical one-dimensional scanner 12. The mechanical one-dimensional scanner 12 reflects the mapping image to a critical optics device 2. The critical optics device 2 transforms the mapping image into a hologram and projects the hologram onto user's pupils 3 for a user to watch.

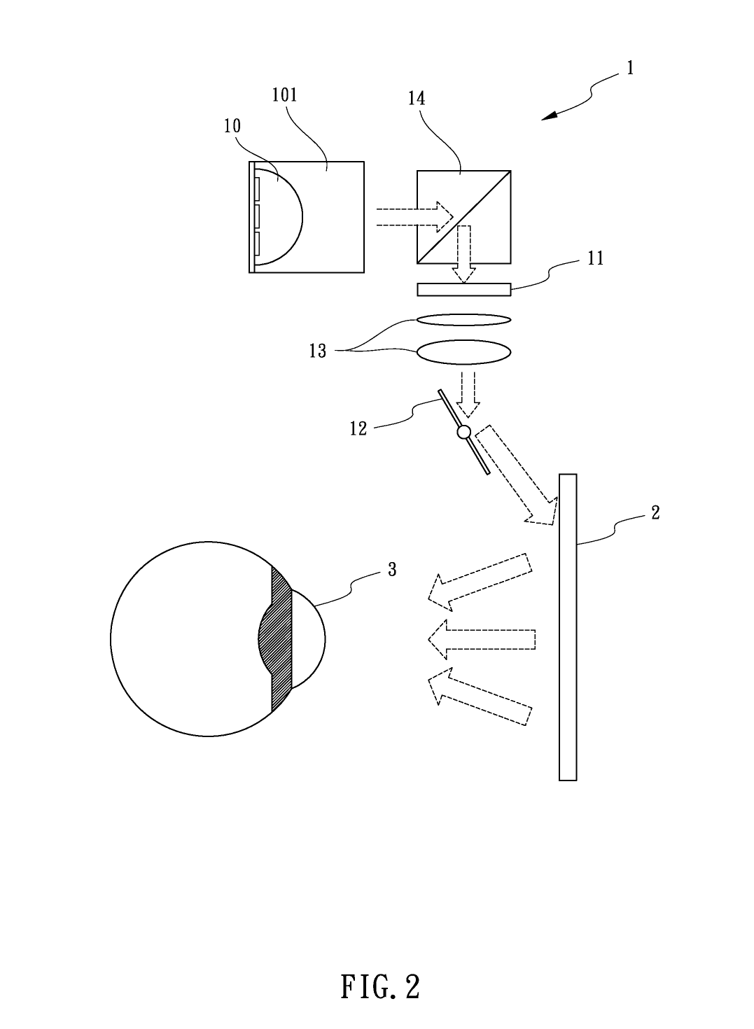

Referring to FIG. 2, the light source 10 in the second embodiment of the present invention emits light beams with a constant wavelength to pass through the light guide element 101. The light guide element 101 unambiguously projects the receiving image onto the displayer 11 via the light splitter 14. The displayer 11 is a light-guiding panel in the second embodiment. The mapping image on the displayer 11 is transmitting through the lens set 13 to reach to the mechanical one-dimensional scanner 12. The mechanical one-dimensional scanner 12 reflects the mapping image to a critical optics device 2. The critical optics device 2 transforms the mapping image into a hologram and projects the hologram onto user's pupils 3 for the user to watch.

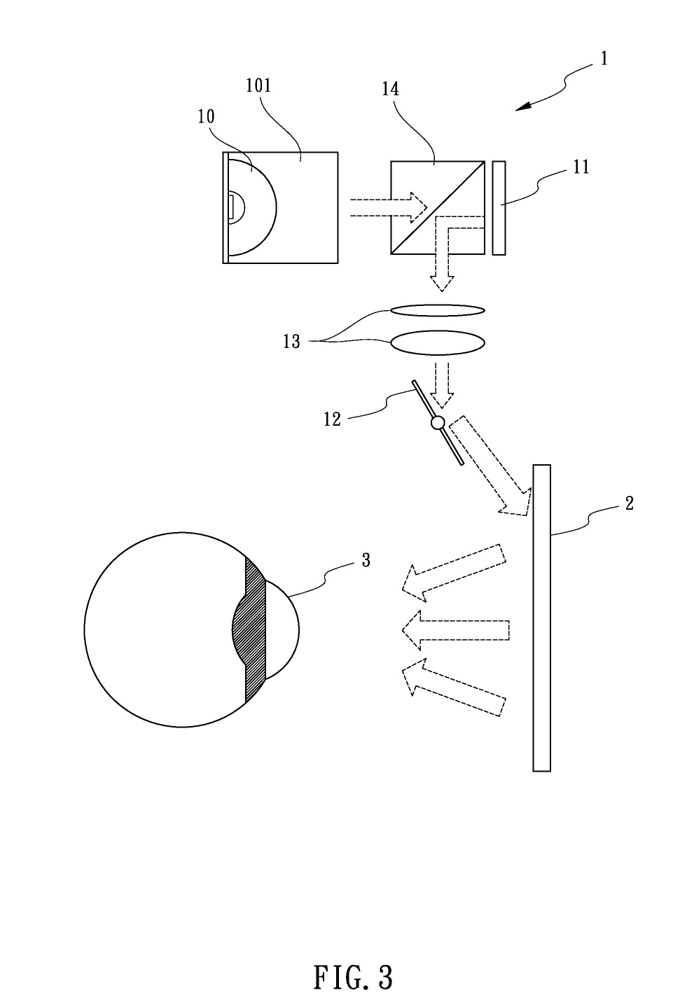

Referring to FIG. 3, the arrangement of the third embodiment is identical to the first embodiment which is shown in FIG. 1, but the light source 10 in the third embodiment is a white-light LED with blue-fluorescent mono-crystalline or blue-fluorescent bi-crystalline.

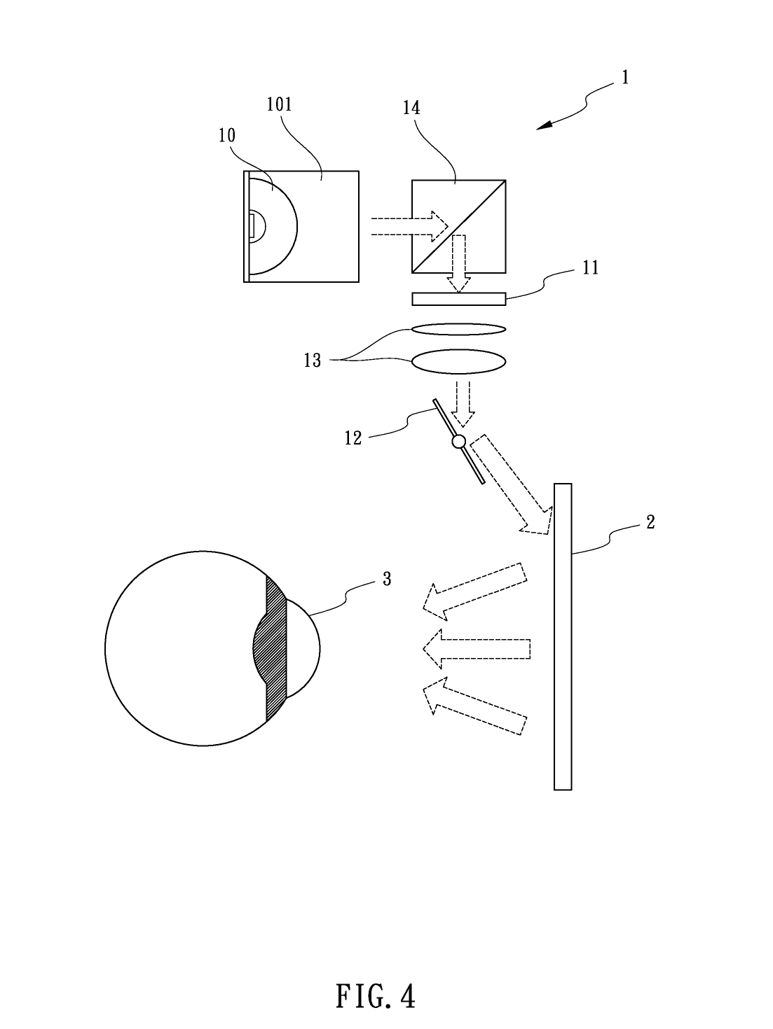

Referring to FIG. 4, the arrangement of the fourth embodiment is identical to the second embodiment which is shown in FIG. 2, but the light source 10 in the fourth embodiment is the white-light LED with blue-fluorescent mono-crystalline or blue-fluorescent bi-crystalline.

The light source 10 mentioned above might be (Red, Green, Blue), (Red, Green, Green, Blue), (Red, Green, Yellow, Blue) . . . LEDs mixing with a white-light LED, or a single white-light LED with blue-fluorescent mono-crystalline or blue-fluorescent bi-crystalline. In addition, the illuminating mode of the light source 10 is a Lambertian light mode. The light source 10 is radiating light beams uniformly in all orientations and the light beams pass through the light guide element 101 to map onto the displayer 11 unambiguously.

The light guide element 101 can be replaced by a light diffuser or a combination of a light guide device and the light diffuser in order to completely transmit the receiving image through the light splitter 14 to map onto the displayer 11.

The mechanical one-dimensional scanner 12 further comprises a reflective sheet pivoted on an axis. The reflective sheet is rotating or vibrating with a constant angle increment. The mechanical one-dimensional scanner 12 is rotating within a constant angle range to receive light beams and to reflect the receiving light beams to the displayer 11. When the mechanical one-dimensional scanner 12 rotates to each of different angles, the incident angle and reflective angle are changed simultaneously so that the image received by the critical optics device 2 is also adjusted.

The critical optics device 2 is a holographic optics device. The holographic optics device is light and small. The holographic optics device can select some specific spectrum of light and filter other light not within the spectrum. The holographic optics device can also allow incident beam within some specific incident angle range to be diffracted into the user's pupils 3 along a certain path.

The mechanical one-dimensional scanner 12 rotates to reflect the light beams within the specific incident angle range to the critical optics device 2 so that most of the light beams can reach to the critical optics device 2 and reduce the energy loss of light beams to the air. Thereafter, the hologram is mapping onto the user's pupils 3 unambiguously from the critical optics 2.

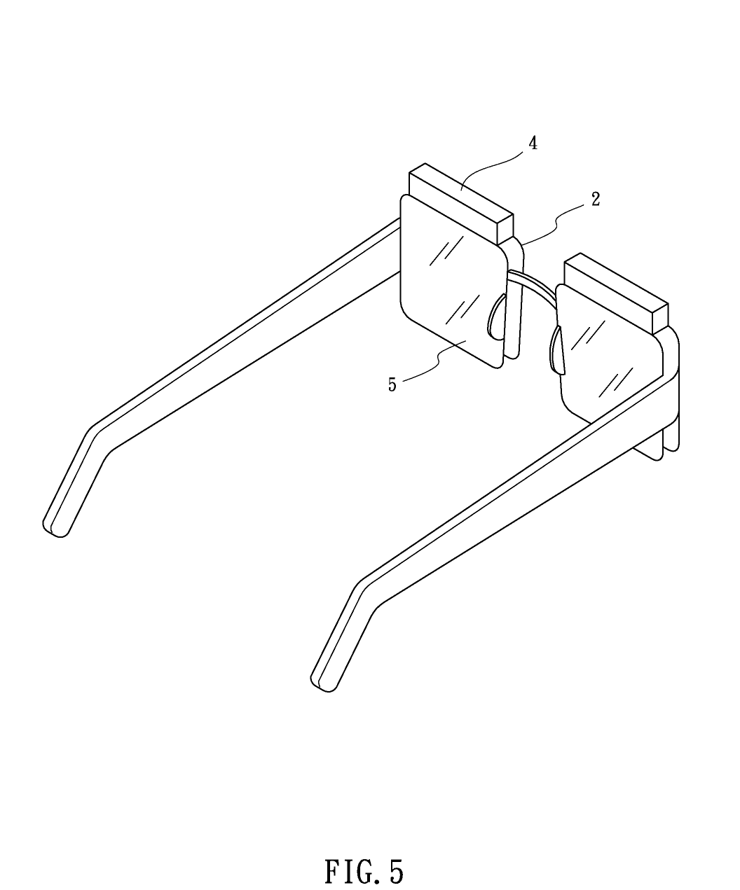

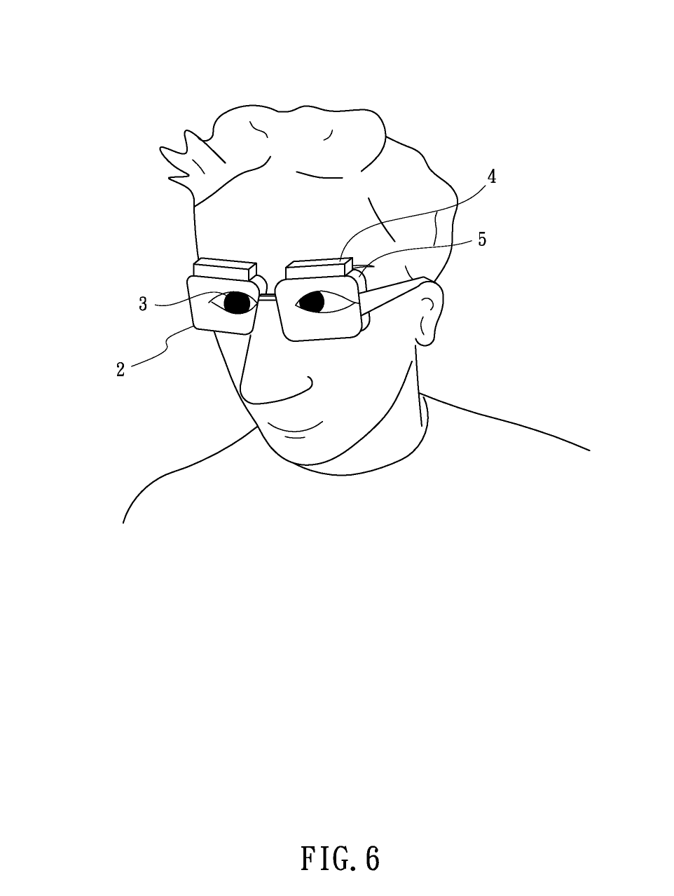

Referring to FIGS. 5-6, the one-dimensional scanning displayer 1 is set up on a pair of glasses. The one-dimensional scanning displayer 1 is shielding in a rectangular shell 4. The critical optics device 2 is in front of eyeglasses 5 so that the image transmitted from the one-dimensional scanning displayer 1 to the critical optics device 2 is passing through the eyeglasses 5 to map onto the user's pupils 3. The one-dimensional scanning displayer for projecting image onto pupils not only provides digital images which the user wants to know, but also provides the hologram of the situation around the user itself

Although the invention has been explained in relation to its preferred embodiment, it is to be understood that many other possible modifications and variations can be made without departing from the spirit and scope of the invention as hereinafter claimed.

What is claimed is:

1. A one-dimensional scanning displayer for projecting image onto pupils comprising:
a light source, a displayer, a mechanical one-dimensional scanner, a lens set, a light splitter and a critical optics device, the light source emitting light beams through a light guide element, the light guide element unambiguously projecting a receiving image onto the displayer via the light splitter, a mapping image on the displayer transmitting through the lens set to reach to the mechanical one-dimensional scanner, the mechanical one-dimensional scanner reflecting the mapping image to a critical optics device, the critical optics device transforming the mapping image into a hologram and projecting the hologram onto user's pupils for a user to watch.

2. The one-dimensional scanning displayer for projecting image onto pupils as claimed in claim 1, wherein the light source is a plurality of LED illuminants with different colors mixing with a white-light LED.

3. The one-dimensional scanning displayer for projecting image onto pupils as claimed in claim 1, wherein the light guide element can be replaced by a light diffuser or a combination of a light guide device and the light diffuser.

4. The one-dimensional scanning displayer for projecting image onto pupils as claimed in claim 1, wherein the mechanical one-dimensional scanner further comprises a reflective sheet pivoted on an axis, the reflective sheet rotating or vibrating with a constant angle increment.

5. The one-dimensional scanning displayer for projecting image onto pupils as claimed in claim 1, wherein the critical optics device is a holographic optics device.
